(19) United States
(12) Patent Application Publication
(10) Pub. No.: US 2026/0094172 A1
(43) Pub. Date: Apr. 2, 2026

(54) CAUSAL VALIDATION OF MULTIVARIATE REGRESSION MODELS

(71) Applicant: Maplebear Inc., San Francisco, CA (US)

(72) Inventors: Tilman Drerup, Berkeley, CA (US); Steven Ji, Somerville, MA (US); Toban Wiebe, Johnson City, TN (US)

(21) Appl. No.: 18/900,463

(22) Filed: Sep. 27, 2024

(51) Int. Cl. G06Q 30/0201

(52) U.S. Cl. CPC G06Q 30/0201

(57) ABSTRACT

To evaluate the causal generalizability of multivariate regression models (such as marketing mix models) that evaluate a plurality of input features that may have high correlation and confounding causality, a model architecture is evaluated with respect to experimental data that varies feature values. The model architecture is trained with training data that excludes the experimental data. The trained model is then applied to predict the outcome of the experimental data inputs and the predicted outcome is scored with respect to the experimental outcome. This may be repeated across more than one experiment to evaluate how the model architecture generalizes to different types of variations in different experiments. The scores may then be used to validate the causal predictions and select or confirm a model architecture for use.

### BACKGROUND

In many applied fields, multivariate regression models are used to predict outcomes based on several independent variables. However, one of the key challenges is causal validation—i.e., ensuring that the relationships identified by the model are truly causal and not merely correlational. This becomes especially difficult when dealing with confounding variables or when external factors that influence the outcome are not properly accounted for, leading to potentially biased or misleading interpretations of the model's results.

In marketing fields, a common type of multivariate regression model is called a marketing mix model. Marketing mix models are commonly used to analyze how marketing interventions as well as other factors affect an outcome. Such models may consider a large number of features that interact with one another in unknown ways in affecting the outcome and, moreover, may consider such features over time (e.g., as a time-series). Some of the features may also be changeable or controllable, and one purpose of the model may be to predict the effect of changing controllable feature values in the future. Examples of controllable features may include the advertising spend on a particular marketing channel.

However, such models typically measure correlation of particular features' effects on the outcome and cannot directly predict causal relationships from a change in a particular feature to a change in an outcome. Even where these models may have fit the prior data effectively, they may still significantly err in future predictions. In addition, in many cases, various types of models with different configurations (e.g., varying architectures, hyperparameters, etc.) may appear to provide similarly effective predictions of the presented training data (i.e., with respect to training data fit or validation on held-out training data). Despite the apparent success of these models when fit to prior data, they may vary widely in efficacy when applied to unseen future data. As such, evaluating differences between real-world application of trained models may be difficult, particularly where the aim of the marketing mix model is to determine modifications to controllable features. In addition, individual trained models may appear to effectively fit variation of a particular feature, but may not be generalizable to other features or situations, such that the generalizability or overall robustness of a trained marketing mix model may be difficult to effectively quantify, reducing overall trust in the model's predictions for causal relationships.

### SUMMARY

In accordance with one or more aspects of the disclosure, various model architectures are evaluated using experimental data that is withheld from training the respective marketing mix models. The model architectures may have different modeling components, layers, functions, number of parameters, hyperparameters, and so forth. The various model architectures generally receive a plurality of features, which may include time-series data that varies over time, and output one or more outcome predictions and estimates of the effect of the features on the outcome. To evaluate the different model architectures, each model architecture is evaluated for a particular experiment by training the marketing mix model for a model architecture using training data that omits data for the experiment and then compares the predicted impact of a feature to the impact estimated using the experimental data. As such, performance of the trained models are evaluated with respect to the experiments that were withheld from training. Different experiments may vary different features by different amounts, such that evaluating a particular model with respect to different experiments may indicate how well the model generalizes to variation across the several features. For example, the experiments may “pulse” the value of a feature by modifying the feature by a percentage, which may be randomized, or may modify the value of a feature in different geographical areas.

This scoring may then be used to estimate the model's capability for generalizing across several types of features. The scoring thus operates as an effective proxy for measuring the model's ability to correctly predict outcomes when modifying features, including those additional features that were not varied in experiments (e.g., for which experiments were not or cannot be run). By comparing the scoring for multiple experiments, a model architecture can be evaluated that most-effectively generalizes across variation in different features. The selected model architecture is then trained with all available training data, which may include the data from experiments, and may be used for subsequent predictions, including how choosing to modify features may modify outcomes. The features may then be modified based on the predictions to optimize one or more goals of the system. As such, the extent to which different model architectures successfully predict various feature changes can be measured and different architectures can be distinguished by their ability to successfully predict the various experimental outcomes. This approach is particularly valuable when the models may otherwise appear equally effective in fitting prior data and when obtaining experimental data may be particularly costly to obtain.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 shows an example data flow for a marketing mix model, in accordance with one or more embodiments.

FIG. 4 shows an example of evaluating a marketing mix model based on experimental data, in accordance with one or more embodiments.

FIG. 5 is a flowchart for a method of evaluating marketing mix models, in accordance with one or more embodiments.

### DETAILED DESCRIPTION

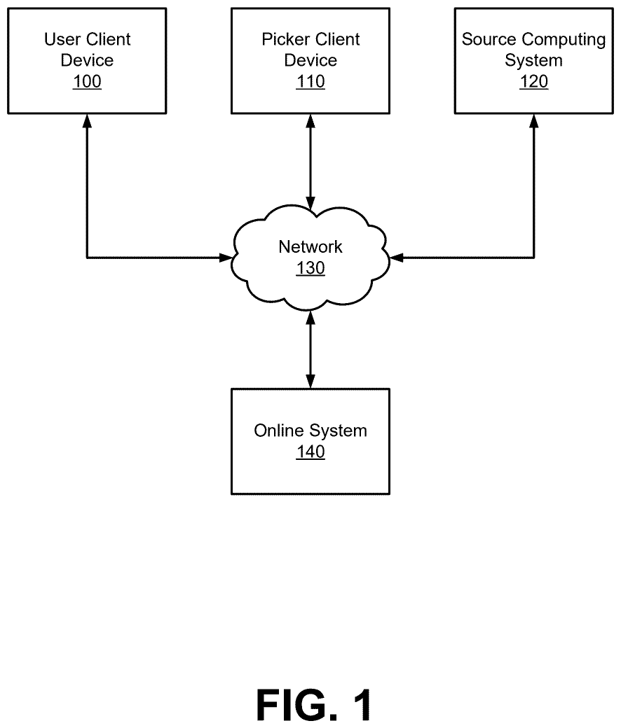

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

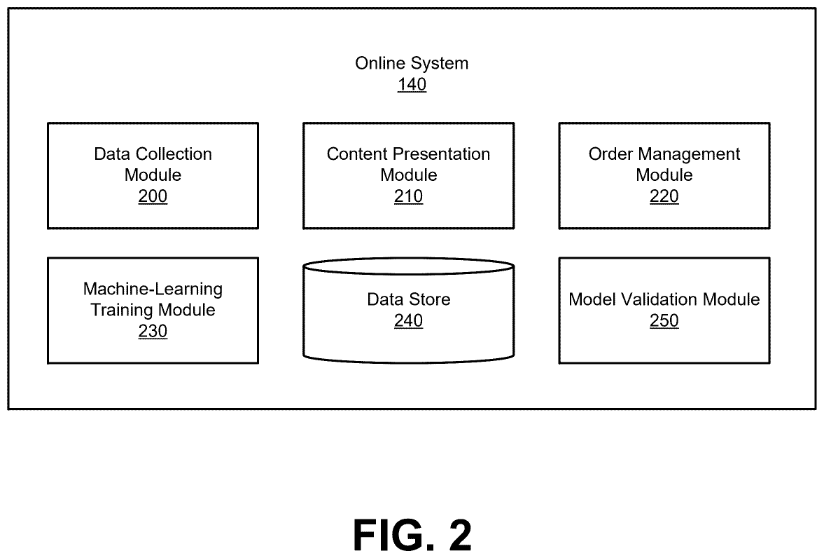

As an example, the online system 140 may allow a user to order groceries from a grocery store source. The user's order may specify which groceries they want to be delivered from the grocery store and the quantities of each of the groceries. The user's client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with one or more embodiments. The system architecture illustrated in FIG. 2 includes a data collection module 200, a content presentation module 210, an order management module 220, a machine-learning training module 230, a data store 240 and a model validation module 250. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

A model validation module 250 validates marketing mix models that may be used by the online system 140 and trained by the machine-learning training module 230. A marketing mix model generally may provide for correlational analysis of a plurality of features to determine a predicted output for particular values of the plurality of features. In many cases, such marketing mix models are applied to contexts in which causation may be difficult to determine and where it may be impossible to isolate individual features'effects on an outcome. For example, the online system 140 may use a marketing mix model to predict expected demand for a particular item, predict a number of orders placed in a timeframe, the volume of orders (e.g., across a week), expected demand for computing resources on the online system 140, and so forth. In many cases, there may be certain features that can be controlled or affected by the online system 140, while other relevant features may not be changeable. As one example, the marketing mix model may predict an outcome predicting a number of new users of the online system 140 or a number of orders placed by users of the online system 140. Some controllable features may characterize promotions, discounts, advertising on different channels, and other means of actively promoting use of the online system 140. However, other factors may also affect these outcomes that are not controllable (or are less controllable), such as the season (e.g., time of year), item pricing, economic environment, estimated time for delivery, competitive substitutes, and so forth.

For convenience in this disclosure, a marketing mix model that has been trained on a particular data set may simply be referred to as a “marketing mix model.” Each marketing mix model may have a different model architecture, which may refer to various characteristics of the operation and/or training of the marketing mix model, such as the structure and interrelationship between tunable parameters of the marketing mix model (e.g., the number of parameters used in the model, the particular number and type of functional layers used in the model, etc.) along with hyperparameters that may describe the training process and methodology for the model, such as a training algorithm, parameters used in the training algorithm (e.g., step size, batch size, etc.), and so forth. For example, different model architectures may be regression models with varying complexity, such as linear, parabolic, quadratic, or cubic, and so forth. A particular model architecture thus may refer to a particular configuration of these characteristics. Different model architectures may thus represent different configurations that learn to predict outcomes in different ways based on the same training data. As such, trained models with different model architectures may perform differently in predicting outcomes for unseen data that may not be effectively captured or described by the apparent efficacy of the model in learning the training data.

Because various model architectures may appear to effectively fit the available training data, the model validation module 250 evaluates performance of one or more marketing mix architectures. As discussed further below, the model validation module 250 may use experimental data to determine how well a model architecture can generalize to feature modification. The model validation module 250 may validate a particular model architecture (e.g., determine that it performs sufficiently well) or may select one model architecture from among several architectures based on the performance of the model architectures relative to one another. The selected model architecture may be used to train the desired model and used to determine modifications to the controllable features based on predicted effects on the outcome. In addition, although certain applications discussed herein relate to the online system 140, one or more embodiments include evaluating marketing mix models of various types in various contexts.

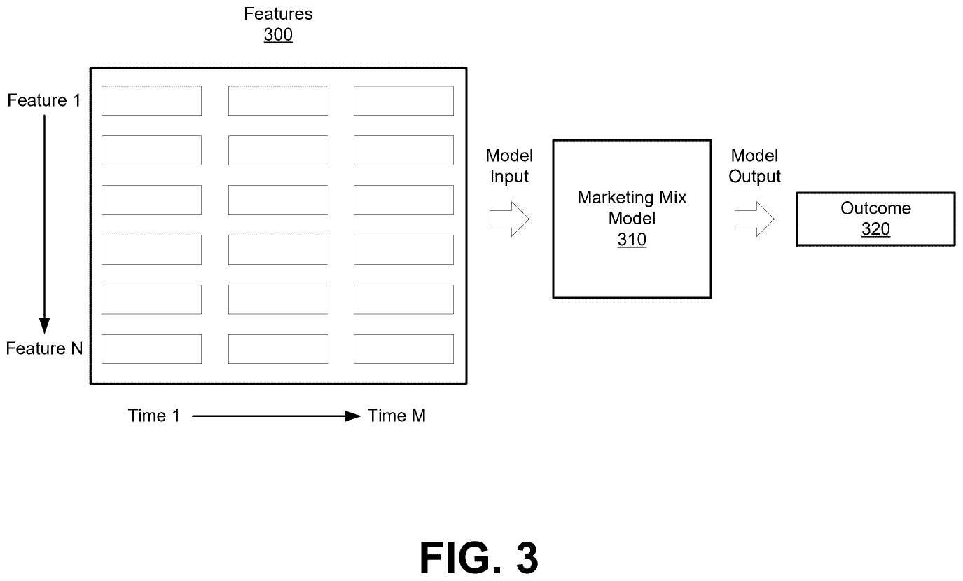

FIG. 3 shows an example data flow for a marketing mix model 310, in accordance with one or more embodiments. In general, the marketing mix model 310 may receive a set of features 300 to predict an outcome 320. Typically, the features 300 includes a plurality of different types of features (e.g., feature 1 to feature N) and may include values of the features as a time-series (e.g., time 1 to time M). In general, the marketing mix model 310 thus receives the input features 300 and determines an outcome 320 based on the trained parameters of the marketing mix model 310. To train the marketing mix model 310, the training data may include training data examples in which the features 300 are varied and associated with particular known values of the related outcome 320. In one or more embodiments, the marketing mix model 310 may output multiple outcomes 320, although only one outcome 320 is shown in FIG. 3.

Although the training data may include various values of the different features over time, in many cases, the values of the features may be highly correlated with one another. In addition, the features may capture only a portion of the relevant aspects of the environment and, although the marketing mix model 310 may effectively learn correlative relationships, it may be unable to capture true causation (e.g., of changing a particular feature value and its effect on the outcome 320). This may be particularly true for regions of the input space that were not included in the training data.

In addition, in many cases (i.e., types of applications of the marketing mix model 310), the training data for the marketing mix model represents real-world time-series information, for which certain features may not be controllable and others may be difficult to modify without significant tradeoff. For example, modifying a controllable feature to better understand its effects may inadvertently reduce a desired outcome. To select marketing mix models that may best generalize to the input features, experimental data may be used that varies certain features and results in a measurable outcome. A marketing mix model may be trained without the experimental data (e.g., the data may be “held out”) to then evaluate the marketing mix model's performance when predicting the experimental outcome. By performing this evaluation against a plurality of experiments, the performance of a model architecture can be assessed with respect to its ability to correctly generalize to the different feature variations of the experiments.

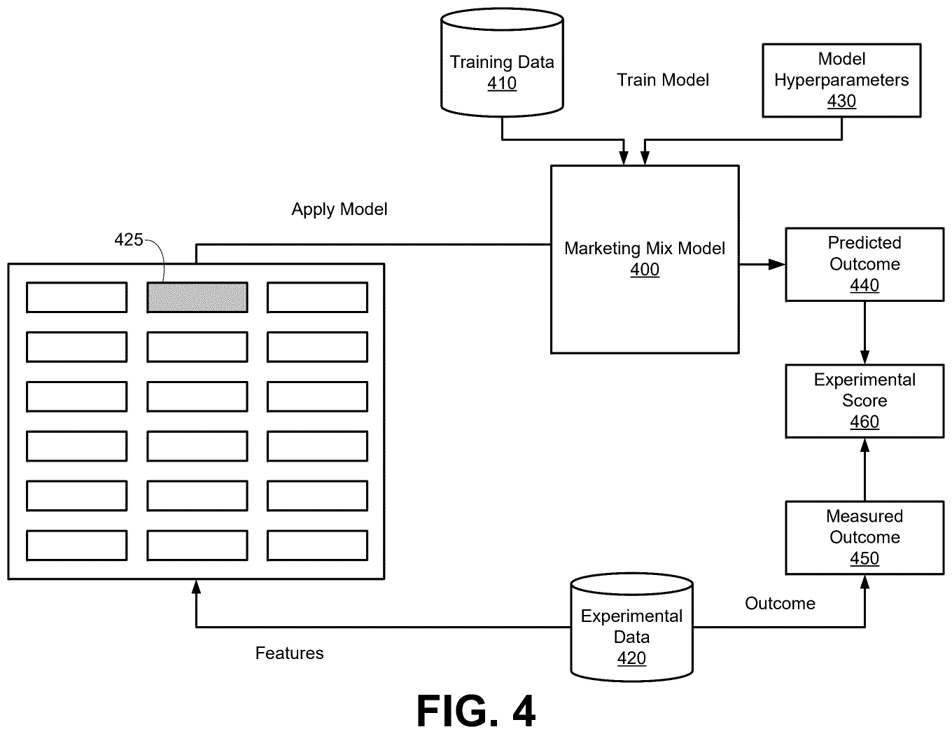

FIG. 4 shows an example of evaluating a marketing mix model 400 based on experimental data 420, in accordance with one or more embodiments. The data flows shown in FIG. 4 are managed, in one or more embodiments, by the model validation module 250. In this example, a marketing mix model 400 is trained with a set of training data 410 and a set of model hyperparameters 430. The model hyperparameters 430, along with other characteristics of the model, may form a particular “model architecture” for the training. Performance of marketing mix model 400 thus may represent a particular model architecture (e.g., including various model hyperparameters) as trained for the particular training data 410. The training data 410 may include various types of data that may be relevant for the performance of marketing mix model 400, and in one or more embodiments may include experimental data related to experiments other than experimental data 420. As such, in some embodiments, the marketing mix model 400 is trained with training data 410 that excludes the experimental data 420, such that the experimental data 420 may be “held out” from the training data 410.

In general, a particular experiment may include modification of one or more features, such as a first feature 425. The modified feature typically includes intentional variation of one of the values of the controllable features relative to values that may otherwise be present in the training data 410. For example, the value of the feature 425 may be increased or decreased by an amount or a percentage, and may include a semi-randomized increase. In time-series data, such as the example of FIG. 4, the feature may be varied for less than all time periods of the data. For example, the value may be “pulsed” in one or more time periods to increase or decrease the value. In one or more embodiments, the feature 425 may be set to zero in the experiments. In general, the experiments are typically performed on a live system that is to be modeled by the marketing mix model 400. For example, when the marketing mix model 400 is used to predict an outcome related to quantity of user orders with features including pricing of items or use of particular promotion channels, the experiment may vary the pricing of an item or the amount of advertising allocated to a particular promotion channel. In the example of FIG. 4, the feature 425 is varied in the experiment.

To evaluate the marketing mix model 400 (i.e., the particular model architecture trained with the set of training data 410), features for the experimental data 420 are applied as an input to the marketing mix model 400 to generate a predicted outcome 440 of the model. A measured outcome 450 from the experiment is then compared with the predicted outcome 440 to determine an experimental score 460. The experimental score 460 measures the extent to which the predicted outcome 440 is similar to the measured outcome 450.

Although certain features may be expressly modified in the experiment, other features may still change, such as uncontrollable features used by the marketing mix model 400. In this example, features that describe other user behaviors, economic conditions, and other characteristics may still change over time as one (or more) controllable features are intentionally modified. Because the experimental data 420 was held out from the model training and typically varies a feature to a value different from values seen in the training data 410, the marketing mix model 400 thus demonstrates its generalizability in predicting the likely effect of varying the feature(s) relevant to the experiment despite the uncontrollable changes in certain features.

In additional examples, the experiments may include geographic and/or other randomization that provide for A/B comparisons of the measured outcome 450 of the experiment. For example, a feature that modifies the user interface of the online system (e.g., a portion of items suggested to a user related to promoted items) may be randomized into a first group or a second group, such that the outcome for the groups can be associated with each of the groups. Similarly, the experimental data 420 may vary a feature for a particular region, such that one region receives one feature value and another region receives another feature value. In these instances, the differences in the measured outcomes 450 for the different groups/regions may be compared with predicted outcomes 440 of the respective groups/regions to determine an experimental score 460 describing how well the marketing mix model 400 predicted outcomes 440 similar to the actual measured outcome 450.

In one or more embodiments, the process of FIG. 4 may be performed multiple times to determine the performance of the model architecture with respect to a plurality of different experiments. For each experiment, the experimental data 420 for that experiment may be withheld from the training data 410 of a particular model architecture. The experimental data may be applied to the model to determine an experimental score 460 for that experiment. The experimental scores across the plurality experiments may then be combined (e.g., with a statistical value such as a mean or median) to determine an overall experimental score 460 for the model architecture. Since the same model architecture may be re-used for a plurality of experiments, the overall score may thus indicate overall “quality” of that model architecture in successfully generalizing to various types of experiments. In one or more embodiments, the model architecture may thus be evaluated with a plurality of different experiments that vary different features and/or different periods of the time-series. By exploring the ability of a model architecture to predict measured outcomes from an experiment, the experimental score 460 provides a way to measure the generalizability of the model architecture, improving confidence in the model's capability to predict outcomes for modifying controllable features in other contexts, including those for which no experiments have been run or assessed by the model.

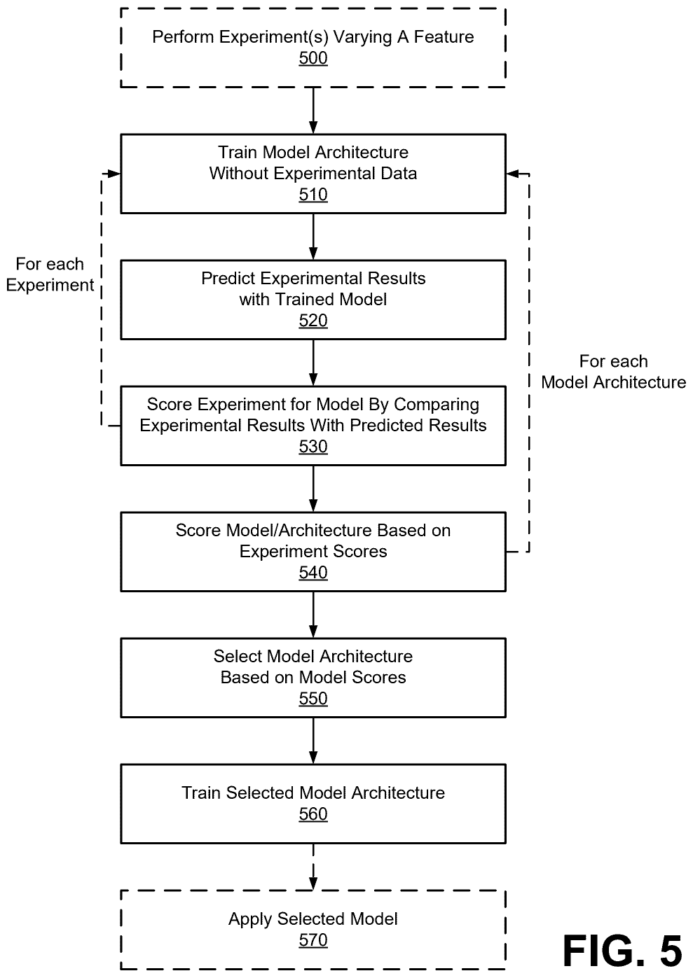

FIG. 5 is a flowchart for a method of evaluating marketing mix models, in accordance with one or more embodiments. Alternative embodiments may include more, fewer, or different steps from those illustrated in FIG. 5, and the steps may be performed in a different order from that illustrated in FIG. 5. These steps may be performed by an online system (e.g., online system 140). Additionally, each of these steps may be performed automatically by the online system without human intervention.

To evaluate the generalizability of a model architecture, one or more experiments may be performed 500 that vary a feature of the system/environment associated with the features and outcome predicted by the marketing mix model. In many cases, the features may include one or more controllable features that may be modified by an administrator and/or the online system, along with one or more uncontrollable features that may describe aspects of the environment. In general, the trained marketing mix model may be used to evaluate and predict likely outcomes for changing one or more controllable features to particular values. For example, the marketing mix model may be used to generate (i.e., predict) a response curve for the outcome based on the value of a controllable value (or a plurality of controllable values) to aid in determining preferred/optimal values of the controllable values. Various experiments may be performed to vary the features as discussed above, for example with a “pulse” of the value of the feature, A/B testing, and other variations of the feature values expected to differ from the training data.

To evaluate a particular model architecture with respect to a particular experiment, the model architecture is trained 510 using training data that excludes the experimental data being evaluated. As discussed above, this enables prediction 520 of outcomes for the experiment using the trained marketing mix model that can be used to score 530 the generalizability of the marketing mix model by comparing the experimental results with the predicted results. In one or more embodiments, multiple experiments may be evaluated for a particular model architecture: by training 510 the model architecture, predicting 520 experimental results using that trained model, and scoring 530 the experiment. The model architecture is scored 540 based on the experiment scores for the various experiments. In one or more embodiments, the model architecture may be trained 510 once with respect to a set of training data that excludes data from a plurality of different experiments, such that the same trained models may be applied to predict outcomes of the different experiments.

This process may also be repeated for a plurality of model architectures, such that each model architecture may be evaluated with respect to one or more experiments. Using the model scores, the respective quality of the model architectures may be compared with one another, or evaluated against a threshold, to select a model architecture to be used for various applications of the model. In one or more embodiments, the respective scores of the model architectures are compared, and the best-scoring (e.g., the highest) scoring model architecture is selected for use. In one or more embodiments, the score of a model architecture may be compared with a threshold and selected when the score is above or below the threshold, such that the score may be “validated”for sufficient quality when compared with the threshold. Performing well with respect to the experiments may indicate that the model architecture effectively generalizes to additional data beyond the training data with different characteristics, providing additional confidence in the model's predictions to other features.

In addition, in some embodiments, the model architectures may appear to perform similarly when evaluated with respect to a validation set (e.g., by randomly splitting known data into training and validation sets) or with cross-validation across training data (e.g., with K-fold cross-validation). Such approaches typically include data having similar characteristics to the training data and may also fail to address causal relationships. By introducing and scoring models with experimental data that may differ from the training data (e.g., experimenting in ranges of controllable values that differ from values in the training data), the scoring based on experimental data can verify that the evaluated model has causal predictive power for the experimental data. As such, in one or more embodiments a plurality of model architectures may be evaluated with respect to a randomly-selected validation set (or another validation approach) and a first model architecture may be the best-performing model when evaluated when evaluated with the randomly-selected validation set. However, a different model may be selected 550 based on the model scores from the experiments, as this model may better account for different data variations.

In one or more embodiments, after selecting 550 the model architecture, the selected model architecture may be trained 560 on the relevant training data, and may include training data from the one or more experiments. As such, the resulting model from the selected model architecture may fine-tune its parameters to even-better account for the additional data available in the experiments. The marketing mix model may be applied in various ways according to the particular applications of the marketing mix model. For example, predictions from the marketing mix model may be used to predict customer orders based on modifications to price or promotions.

Finally, the selected model may be applied 570 to predict the outcomes for various features. This may be used, for example, to predict outcomes related to variations of controllable features. For example, a feature variation curve may be calculated that indicates the predicted outcomes across a range of values of a particular controllable feature. As another example, controllable features may be associated with a cost, such that the predicted outcome may be optimized across a plurality of controllable features to optimize the outcome according to the cost (or another joint measure of the features). In one or more embodiments, the application of the model includes automatically applying changes to the controllable features based on the predictions of the marketing mix model.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
identifying a set of experiments, each experiment including at least one set of input features and at least one experimental outcome;
for each experiment in the set of experiments:
training one or more marketing mix models with training data that excludes data for the respective experiment, wherein each marketing mix model predicts an outcome based on a set of input features according to a model architecture that is selected from a plurality of model architectures,
applying each trained marketing mix model to at least one set of input features to predict an outcome, and
generating an experiment score for each trained marketing mix model by comparing the predicted outcome to the experimental outcome;
scoring one or more model architectures associated with the one or more marketing mix models based on the experiment scores;
selecting a model architecture based on the scoring; and
deploying a marketing mix model, wherein the deployed marketing mix model predicts an outcome based on a set of input features according to the selected model architecture.

2. The method of claim 1, further comprising:
training the deployed marketing mix model with training data including data from at least one of the set of experiments.

3. The method of claim 1, wherein selecting the model architecture based on the scoring comprises comparing the experiment scores to a threshold.

4. The method of claim 1, wherein deploying the selecting marketing mix model comprises:
applying the marketing mix model to select values of feature values of the set of input features and to apply the selected values to an environment modeled by the set of input features.

5. The method of claim 1, wherein the one or more model architectures include a plurality of model architectures that have different model layers, functions, hyperparameters, or training processes.

6. The method of claim 1, wherein identifying the set of experiments comprises identifying a plurality of experiments that vary different controllable input features of the set of input features.

7. The method of claim 1, wherein identifying the set of experiments comprises identifying at least one experiment that modifies one input feature to one or more values not included in a range of values of the training data that excludes data for the experiment.

8. The method of claim 1, wherein identifying the set of experiments comprises identifying at least one experiment that randomly pulses at least one input feature of the set of input features.

9. The method of claim 1, wherein the plurality of model architectures comprises a regression model.

10. A computer program product comprising a non-transitory computer-readable storage medium having instructions encoded thereon that, when executed by a processor, cause the processor to perform steps comprising:
identifying a set of experiments, each experiment including at least one set of input features and at least one experimental outcome;
for each experiment in the set of experiments:
training one or more marketing mix models with training data that excludes data for the respective experiment, wherein each marketing mix model predicts an outcome based on a set of input features according to a model architecture that is selected from a plurality of model architectures,
applying each trained marketing mix model to at least one set of input features to predict a predicted outcome, and
generating an experiment score for each trained marketing mix model by comparing the predicted outcome to the experimental outcome;
ranking the one or more marketing mix models based on the experiment scores for the one or more marketing mix models for the set of experiments;
selecting a marketing mix model based on the ranking; and
deploying the selecting marketing mix model.

11. The non-transitory computer-readable storage medium of claim 10, wherein the instructions further cause the processor to perform steps comprising:
training the deployed marketing mix model with training data including data from at least one of the set of experiments.

12. The non-transitory computer-readable storage medium of claim 10, wherein selecting the model architecture based on the scoring comprises comparing the experiment scores to a threshold.

13. The non-transitory computer-readable storage medium of claim 10, wherein deploying the selecting marketing mix model comprises:
applying the marketing mix model to select values of feature values of the set of input features and to apply the selected values to an environment modeled by the set of input features.

14. The non-transitory computer-readable storage medium of claim 10, wherein the one or more model architectures include a plurality of model architectures that have different model layers, functions, hyperparameters, or training processes.

15. The non-transitory computer-readable storage medium of claim 10, wherein identifying the set of experiments comprises identifying a plurality of experiments that vary different controllable input features of the set of input features.

16. The non-transitory computer-readable storage medium of claim 10, wherein identifying the set of experiments comprises identifying at least one experiment that modifies one input feature to one or more values not included in a range of values of the training data that excludes data for the experiment.

17. The non-transitory computer-readable storage medium of claim 10, wherein identifying the set of experiments comprises identifying at least one experiment that randomly pulses at least one input feature of the set of input features.

18. The non-transitory computer-readable storage medium of claim 10, wherein the plurality of model architectures comprises a regression model.

19. A system comprising:
a processor that executes instructions; and
a non-transitory computer-readable storage medium having instructions executable by the processor for:
identifying a set of experiments, each experiment including at least one set of input features and at least one experimental outcome;
for each experiment in the set of experiments:
training one or more marketing mix models with training data that excludes data for the respective experiment, wherein each marketing mix model predicts an outcome based on a set of input features according to a model architecture that is selected from a plurality of model architectures,
applying each trained marketing mix model to at least one set of input features to predict an outcome, and
generating an experiment score for each trained marketing mix model by comparing the predicted outcome to the experimental outcome;
scoring one or more model architectures associated with the one or more marketing mix models based on the experiment scores;
selecting a model architecture based on the scoring; and
deploying a marketing mix model, wherein the deployed marketing mix model predicts an outcome based on a set of input features according to the selected model architecture.

20. The system of claim 19, wherein the non-transitory computer-readable storage medium further has instructions executable by the processor for:
training the deployed marketing mix model with training data including data from at least one of the set of experiments.
